(19) United States
(12) Patent Application Publication
(10) Pub. No.: US 2023/0352231 A1
(43) Pub. Date: Nov. 2, 2023

(54) COIL COMPONENT AND PRODUCTION METHOD THEREOF

(71) Applicant: TDK CORPORATION, Tokyo (JP)

(72) Inventors: Katsushi YASUHARA, Tokyo (JP); Yuji SEZAI, Tokyo (JP); Ryoma NAKAZAWA, Tokyo (JP); Hironobu FURUKAWA, Tokyo (JP)

(73) Assignee: TDK CORPORATION, Tokyo (JP)

(21) Appl. No.: 18/307,442

(22) Filed: Apr. 26, 2023

(30) Foreign Application Priority Data
Apr. 28, 2022 (JP) 2022-075284
Apr. 28, 2022 (JP) 2022-075294

(51) Int. Cl. H01F 27/28; H01F 41/02

(52) U.S. Cl. CPC H01F 27/2823; H01F 41/0246; H01F 27/255

(57) ABSTRACT

A coil component including a core part and a coil part formed by winding a conductor in a coil form, in which the coil part is inside of the core part. The core part has a center pole part positioned in an area surrounded by an inner diameter of the coil part. The center pole part includes a first center pole part and a second center pole part each having different predetermined configurations, or the center pole part includes soft magnetic metal particles having predetermined deflection angles and aspect ratios.

This application claims priority to Japanese patent application No. 2022-075284 filed on Apr. 28, 2022 and Japanese patent application No. 2022-075294 filed on Apr. 28, 2022 each of which is incorporated herein by reference in its entirety.

### BACKGROUND

The present disclosure relates to a coil component and a production method thereof.

Patent Document 1 discloses a coil component having a core which is a hexagonal cross-section in a center part.

Patent Document 2 discloses a magnetic component including magnetic cores with various T-shapes.

[Patent Document 1] U.S. Pat. No. 9,318,251
[Patent Document 2] U.S. Pat. No. 9,959,965

### SUMMARY

A coil component according to one aspect of the present disclosure includes a core part and a coil part formed by winding a conductor in a coil form, wherein
the coil part is inside of the core part;
the core part includes a center pole part positioned in an area surrounded by an inner diameter of the coil part;
the center pole part includes a first center pole part including first soft magnetic metal particles, and a second center pole part including second soft magnetic metal particles and being arranged around the first center pole part;
the first center pole part includes at least two opposing faces opposing each other;
the two opposing faces are parallel to a winding axis direction; and
an average deflection angle of the first soft magnetic metal particles against the winding axis direction of the coil part and an average deflection angle of the second soft magnetic metal particles against the winding axis direction of the coil part are different.

A coil component according to another aspect of the present disclosure includes a core part and a coil part formed by winding a conductor in a coil form, wherein
the coil part is inside of the core part;
the core part includes a center pole part positioned in an area surrounded by an inner diameter of the coil part;
the center pole part includes a first center pole part including first soft magnetic metal particles, and a second center pole part including second magnetic particles and being arranged around the first center pole part;
the first center pole part includes at least two opposing faces opposing each other; and
the two opposing faces are parallel to a winding axis direction.

A coil component according to another aspect of the present disclosure includes a core part including soft magnetic metal particles, and a coil part formed by winding a conductor in a coil form, wherein
the coil part is inside of the core part;
the core part includes a center pole part positioned in an area surrounded by an inner diameter of the coil part;
an average value of cos 2θ of the soft magnetic metal particles included in the center pole part is 0.1 or larger, in which θ represents deflection angles of the soft magnetic metal particles against the winding axis direction of the coil part; and
an average aspect ratio of the soft magnetic metal particles included in the center pole part is 1.1 or larger.

A production method of the coil component according to one aspect of the present disclosure includes steps of
preparing a center core by pressing; and
arranging the center core so that a pressure applied direction of the center core while pressing is perpendicular to a winding axis direction of the coil part.

### BRIEF DESCRIPTION OF THE DRAWINGS

FIG. 1 is a schematic diagram of an inductor according to one aspect of the present disclosure.

FIG. 2 is a schematic diagram of a cross section along a line I-I of FIG. 1.

FIG. 3 is a schematic diagram for explaining an aspect ratio and a deflection angle of a soft magnetic metal particle.

FIG. 4 illustrates perspective diagrams of members used during producing the inductor according to one aspect of the present disclosure.

FIG. 5 illustrates perspective diagrams of members used during steps for producing the inductor according to one aspect of the present disclosure.

FIG. 6 is a schematic diagram of a cross section of the inductor according to one aspect of the present disclosure.

FIG. 7 is a schematic diagram of a cross section along a line VI-VI of FIG. 6.

FIG. 8 is a schematic diagram showing position of each member prior to thermocompression bonding which is used during the production of the inductor according to one aspect of the present disclosure.

FIG. 9 shows perspective diagrams of members used during the production of the inductor according to one aspect of the present disclosure.

### DETAILED DESCRIPTION

Hereinbelow, an embodiment of the present disclosure is described with reference to the drawings. The following described embodiment of the present disclosure is one example of the present disclosure. Each configurational element according to the embodiment of the present disclosure, such as numerical ranges, shapes, materials, production steps, and so on may be modified or changed within a range which does not cause technical problems.

Also, the shape shown in the drawing of the present disclosure does not necessarily accurately represent an actual shape, since the shape and so on may be modified for explanation.

### First Embodiment

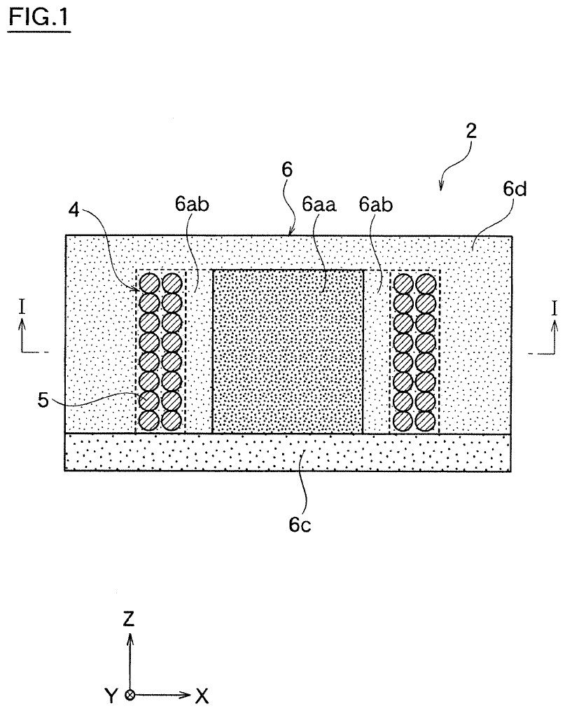

As shown in FIG. 1, an inductor 2 which is one type of a coil component according to the first embodiment of the present disclosure includes a coil part 4 and a core part 6. The coil part 4 is formed by winding a conductor 5 in a coil form. The core part 6 has a center pole part positioned in an area surrounded by an inner diameter of the coil part 4, and an outer peripheral part which is a part besides the center pole part.

The inductor 2 according to the first embodiment of the present disclosure has an upper face and a lower face of the core part 6 which are perpendicular to Z-axis, and a side face of the core part 6 is perpendicular to a plane including X-axis and Y-axis. Also, the winding axis of the coil part 4 is parallel to Z-axis. A shape of the core part 6 is not limited to the shape shown in FIG. 1.

In the present disclosure, “parallel” does not only means “perfectly parallel”, but it also includes “substantially parallel”. In the present disclosure, “parallel” may include an error within a range of manufacturing tolerance, or it may also include an error which is beyond the range of manufacturing tolerance. Specifically, unless mentioned otherwise, a line A is parallel to a line B means that an angle between the line A and the line B is 0° or larger and 10° or smaller. Same applies to the case where either one or both of “line” is replaced with “plane”.

In the present disclosure, “perpendicular” does not only mean “perfectly perpendicular”, but it also includes “substantially perpendicular”. In the present disclosure, “perpendicular” may include an error within a range of manufacturing tolerance, or it may also include an error which is beyond the range of manufacturing tolerance. Specifically, unless mentioned otherwise, a line A is perpendicular to a line B means that an angle between the line A and the line B is 80° or larger and 100° or smaller. Same applies to the case where either one or both of “line” is replaced with “plane”.

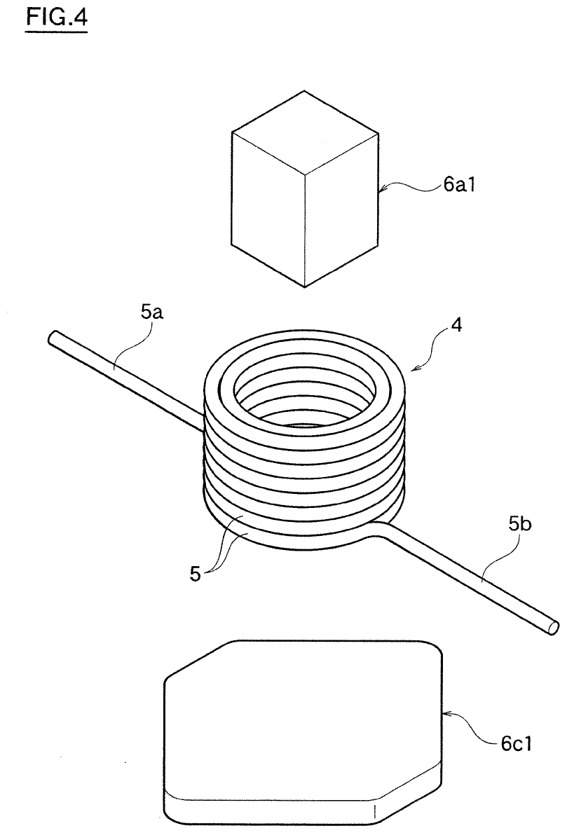

A size of the inductor 2 according to the first embodiment of the present disclosure is not particularly limited. For example, the inductor 2 may be a rectangular parallelepiped shape of which the lower limit of the size, excluding lead wire parts 5a and 5b, may be a bottom face of 2 mm×2 mm with a height of 1 mm. The upper limit of the size, excluding the lead wire parts 5a and 5b, may be a cubic shape having a bottom face of 20 mm×20 mm with a height of 20 mm. The height is a length in Z-axis direction shown in FIG. 1. The lead wire parts 5a and 5b of the coil part 4 shown in FIG. 4 are not shown in FIG. 1. The lead wire parts 5a and 5b are formed to both ends of a conductor constituting the coil part 4. A part of a lead wire part 5a and a part of a lead wire part 5b may be pulled out of the core part 6 shown in FIG. 1.

The conductor (conductive wire) 5 which constitutes the coil part 4 may be coated with an insulation coating layer on the outer circumference of the conductor 5, if needed. A material of the conductor is not particularly limited. For example, the conductor 5 may be constituted of Cu, Al, Fe, Ag, or Au; or it may be an alloy including these metals. A material of the insulation coating is not particularly limited. For example, the material of the insulation coating layer may be polyurethane, polyamide-imide, polyimide, polyester, polyester-imide, and/or polyester-nylon.

A cross section of the conductor 5 is not particularly limited. As for the cross section, a circular shape and a rectangular shape may be mentioned as examples. In the first embodiment of the present disclosure, the cross section of the conductor 5 is a circular shape.

The core part 6 includes at least soft magnetic metal particles. Materials of the soft magnetic metal particles are not particularly limited. For example, the materials of the soft magnetic metal particles may be ferrites such as Mn—Zn ferrite and Ni—Cu—Zn ferrite, or soft magnetic alloys such as Fe—Si alloy, Fe—Si—Al alloy, Fe—Si—Cr alloy, and permalloy (Fe—Ni alloy). A fine structure of the soft magnetic metal particle is not particular limited. The fine structure of the soft magnetic metal particle may be amorphous or it may include crystal. When the soft magnetic metal particle is amorphous, the soft magnetic metal particles may be flattened in advance using a pulverizer and so on. When the soft magnetic metal particle includes crystal, a particle size of the crystal is not particular limited. For example, it may be 1 μm or less.

The core part 6 may include a heat curing resin (binder). A type of the heat curing resin is not particularly limited. As the heat curing resin, for example, an epoxy resin, a diallyl phthalate resin, a phenol resin, polyimide, polyamide-imide, a silicone resin, or a combination of these may be mentioned.

The core part 6 includes a center pole part positioned in the area surrounded by the inner diameter of the coil part 4. The center pole part has a first center pole part 6aa, and a second center pole part Gab arranged around the first center pole part 6aa. The first center pole part 6aa has at least two opposing faces which are opposing to each other. The opposing faces are parallel to the winding axis direction (Z-axis direction of FIG. 1) of the coil part 4. Thereby, inductance of the coil component tends to improve easily. Further, even when a molding pressure during main molding which is described in below is lowered, high inductance may be still obtained. By lowering the molding pressure, load applied to the coil can be reduced, and the coil is less likely to have short circuits. Further, it becomes easy to design a coil component with a low coil resistance, and also to design a compact coil component.

A shape of the first center pole part 6aa may be any shape as long as the first center pole part 6aa at least have two opposing faces opposing to each other. For example, a quadrangular prism may be mentioned. The above-mentioned quadrangular prism includes a quadrangular prism in which corners and ridgelines are chamfered, and also includes a quadrangular prism in which corners and ridgelines are rounded off. In below description, the shape of the first center pole part 6aa is considered to be a quadrangular prism.

A volume ratio of the first center pole part 6aa in the center pole part is not particularly limited. For example, the volume ratio of the first center pole part 6aa may be within a range of 50% or more and 80% or less.

The first center pole part 6aa and the second center pole part 6ab may be differentiated, for example, by observing a cross section of the coil part 4 which is perpendicular to the winding axis direction using SEM and so on. It is possible to differentiate the first center pole part 6aa and the second center pole part Gab by contrast differences. The contrast differences are generated due to differences of the materials, average aspect ratios, average degree of orientations, and/or filling densities of the soft magnetic metal particles included in each center pole part. Also, the contrast differences may be generated due to differences in types of resins and types of inorganic components included in each center pole part, and differences in amounts of resins and inorganic components included in each center pole part. That is, the first center pole part 6aa and the second center pole part Gab are different in at least one selected from, the materials, average aspect ratios, average degree of orientations, filling densities of the soft magnetic metal particles included in each center pole part, types of resins and inorganic components included in each center pole part, and/or in amounts of resins and inorganic components included in each center pole part.

The average degree of orientations of the soft magnetic metal particles may be different in the first center pole part 6aa and the second center pole part 6ab. The average degree of orientation of the soft magnetic metal particles included in the first center pole part 6aa may be larger than the average degree of orientation of the soft magnetic metal particles included in the second center pole part 6ab, and/or the average degree of orientation included in parts other than the center pole part particularly included in outside of the coil part 4. The degree of orientation in the present disclosure refers to a degree of orientation towards the winding axis of the coil part 4.

Specifically, when the deflection angle of the soft magnetic metal particle to the winding axis direction of the coil part 4 is θ, the average deflection angle of the soft magnetic metal particles in the first center pole part 6aa and in the second center pole part 6ab may be different, and cos 2θ may also be different.

In below description, the soft magnetic metal particles included in the first center pole part 6aa are referred to as first soft magnetic metal particles. The soft magnetic metal particles included in the second center pole part 6ab are referred to as second soft magnetic metal particles. The soft magnetic metal particles included in parts outside of the coil part 4 viewing from the winding axis of the coil is referred to as third soft magnetic metal particles.

The deflection angle of the first soft magnetic metal particle against the winding axis direction of the coil part 4 is defined as θα. The deflection angle of the second soft magnetic metal particle against the winding axis direction of the coil part 4 is defined as θβ. The deflection angle of the third soft magnetic metal particle to the winding axis direction of the coil part 4 is defined as θγ. The average of value cos 2θα may be larger than the average value of cos 2θβ and/or the average value of cos 2θγ.

The average value of cos 2θα may be 0.1 or larger, 0.5 or larger, or 1.0.

The average aspect ratio of the first soft magnetic metal particles may be 1.1 or larger, may be within a range of 1.1 or larger and 5.0 or smaller, or may be within a range of 1.5 or larger and 5.0 or smaller.

In below, methods of calculating the average aspect ratio and cos 2θα of the first soft magnetic metal particles are described. The same applies to the second soft magnetic metal particles and the third soft magnetic metal particles. Regarding the aspect ratio and cos 2θ, the soft magnetic metal particle having a long axis diameter which is 10 μm or longer in the cross-section image described in below is subject of measurement. The reason for not measuring the soft magnetic particle having a long axis diameter of less than 10 μm in the cross-section image described in below is because the soft magnetic metal particle with short long axis diameter in the cross-section image may be an end part of the soft magnetic metal particle which the actual size is relatively large. In such case, it may be said that such soft magnetic metal particle is not appropriately observed. Thus, if the soft magnetic metal particle with short long axis diameter in the cross-section is measured, errors of the calculated average aspect ratio and errors of calculated cos 2θ may become large.

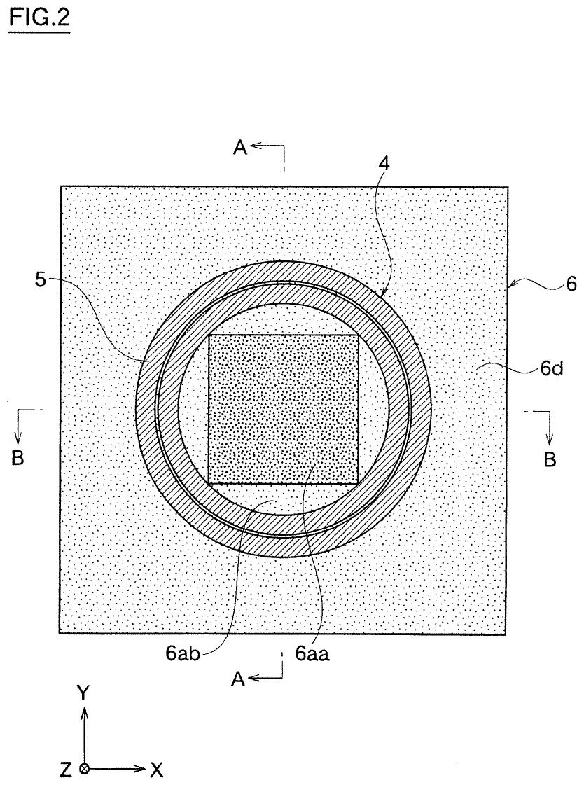

First, the inductor 2 is cut along the line I-I shown in FIG. 1. The obtained cross-section is FIG. 2. Next, the inductor 2 is cut so that the cut made to the inductor 2 is parallel to opposing faces facing each other in the first center pole part baa. Specifically, the inductor 2 is cut along a line A-A shown in FIG. 2 to obtain a cross-section along the line A-A. Also, the inductor 2 is cut along a line B-B which is perpendicular to the line A-A shown in FIG. 2.

The cross-section along the line A-A is observed using a widely used image analysis device to obtain the cross-section image along the line A-A. Further, the cross-section along the line B-B is observed, and the cross-section image along the line B-B is obtained.

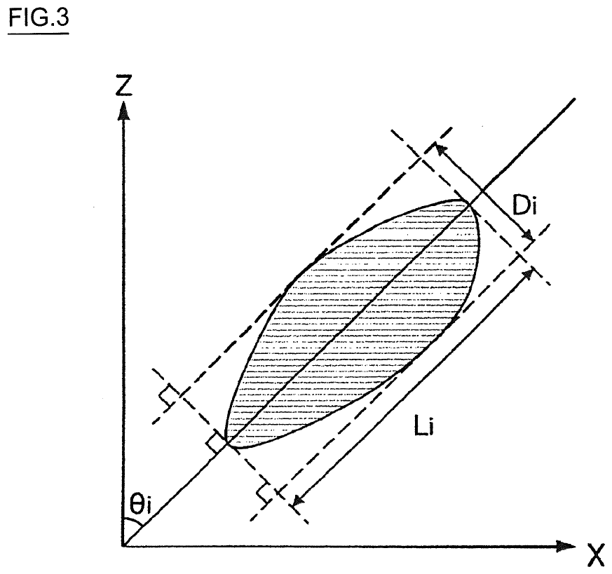

As shown in FIG. 3, when two parallel tangent lines are drawn which are in contact with an outline of a soft magnetic metal particle i observed in the cross-section image, a long axis is a line which connects tangent points where the distance between said two tangent lines is the longest. A length of the long axis is a long axis diameter Lᵢ of the soft magnetic metal particle i. When determining the long axis, the angle between the two parallel tangent lines is 0°.

Also, as shown in FIG. 3, another two parallel tangent lines contacting the outline of the soft magnetic metal particle i observed in the cross-section image are drawn in a way that said another two parallel tangent lines are perpendicular to the above-mentioned two parallel tangent lines where the distance between the above-mentioned two parallel tangent lines is the longest. Then, a short axis is a line which connects another two tangent points where the distance between said another two tangent lines is the longest. A length of the short axis is a short axis diameter Dᵢ of the soft magnetic metal particle i. When determining the short axis, the angle between the two parallel tangent lines is 0°.

From each cross-section image, Σ(Lᵢ/Dᵢ)/N (i=1, 2, . . . N) is calculated, in which Lᵢ represents the long axis diameter, and Dᵢ represents the short axis diameter of the soft magnetic metal particle i, and N represents the number of soft magnetic metal particles included in the first center pole part 6aa. An area per one cross-section image is not particularly limited, for example, it may be 200 μm×200 μm. In the case that the number of soft magnetic metal particles having the long diameter of 10 μm or larger in the cross-section image is less than 100, a plurality of number of cross-section images is obtained to make N≥100. The obtained value is an average aspect ratio from each cross-section image.

The average aspect ratios obtained from each of cross-section image are compared. Among the average aspect ratio from the cross-section along the line A-A and the average aspect ratio from the cross-section along the line B-B, the larger average aspect ratio is an average aspect ratio of the soft magnetic metal particles included in the first center pole part baa.

The cross-section image having the larger average aspect ratio is the cross-section image for calculating the average value of cos 2θ of the soft magnetic metal particles described in below.

In FIG. 3, the winding axis direction of the coil is Z-axis direction. As shown in FIG. 3, the deflection angle θi of the soft magnetic metal particle i against the winding axis direction of the coil is the angle between the winding axis direction of the coil and the long axis of the soft magnetic metal particle i.

The average value of cos 2θ of the soft magnetic metal particles is calculated using Σ cos 2θᵢ/N (i=1, 2, . . . N). The size of the cross-section image is adjusted so that N is N≥100. Σ cos 2θᵢ/N is defined as an average degree of orientation Φ of the soft magnetic metal particles.

When Φ=1, all of the soft magnetic metal particles are oriented in the winding axis direction of the coil. When Φ=0, each of the soft magnetic metal particles are randomly oriented against the winding axis direction of the coil, and the soft magnetic metal particles as a whole is not oriented in any direction. When Φ=−1, all of the soft magnetic metal particles are oriented perpendicular to the winding axis direction of the coil.

Next, a production method of the inductor 2 shown in FIG. 1 is described using FIG. 4.

As shown in FIG. 4, the inductor 2 produced using the production method of inductor 2 according to the first embodiment of the present disclosure is produced by integrating a center core 6a1 which mainly becomes the first center pole part 6aa at the end, a base core 6c1 which mainly becomes an exterior part 6c at the end, a core material (not shown in the figure) which mainly becomes the second center pole part 6ab and an exterior part 6d at the end, and an insert member including the coil part 4 constituted by an air core coil and so on.

The length of the center core 6a1 in Z-axis direction may be the same as the length of the coil part 4 in Z-axis direction, or it may be shorter or longer than the length of the coil part 4 in Z-axis direction.

### (Center Core 6a1)

As materials of the center core part 6a1, a soft magnetic metal powder including the soft magnetic metal particles, and a resin are prepared.

A shape of the soft magnetic metal particle included in the soft magnetic metal powder is not particularly limited. For example, it may be a spherical shape, a flattened shape, or a needle-like shape. An average particle size of the soft magnetic metal particles is not particularly limited. For example, the average particle size may be within a range of 0.5 μm to 50 μm. The soft magnetic metal powder may be obtained by mixing a plurality of types of the soft magnetic metal particles having different shapes, different average particle sizes, and so on. For example, the soft magnetic metal particles which are flattened in advance may be mixed with the soft magnetic metal particles which are not flattened in advance to prepare the soft magnetic metal powder.

The resin is not particularly limited, and for example, it may be an epoxy resin, a phenol resin, a polyimide resin, a polyamide-imide resin, or a silicone resin. Also, a resin combining these resins may be prepared as well.

Next, the soft magnetic metal powder and the resin are mixed for granulation, and granules are obtained. A granulation method is not particularly limited. For example, the resin may be added to a magnetic powder and stirred, and then dried, thereby the granules may be obtained. Also, the average particle size and particle size distribution of the grains may be adjusted appropriately.

A ratio of the resin is not particularly limited, and for example it may be within a range of 1.0 to 6.0 parts by weight to 100 parts by weight of the soft magnetic metal powder.

Before mixing the soft magnetic metal powder and the resin, the insulation coating layer may be formed on the surface of the soft magnetic metal particle. For example, a SiO₂ layer may be formed as the insulation coating layer using a sol-gel method.

After the resin is added to and stirred with the soft magnetic metal powder, coarse granules may be removed by passing through a mesh. The resin may be diluted using a solvent when it is added to the magnetic powder. As the solvent, for example ketones may be mentioned.

Next, the center core 6a1 is prepared using compression molding. Specifically, a mold is filled with the obtained granules, then pressure is applied, thereby the center core 6a1 is obtained. At this time, the soft magnetic metal particles deform, and the soft magnetic metal particles are flattened in a direction of a plane perpendicular to the pressure applying direction. As a result, the soft magnetic metal particles are oriented in a direction perpendicular to the pressure applying direction. Hereinbelow, core molding may refer to a process of forming a core such as the center core 6a1 and so on using compression molding.

The applied pressure during compression is not particularly limited, and the higher the pressure is, the flatter the soft magnetic metal particles are. For example, the applied pressure during compression may be within a range of 300 MPa to 1200 MPa.

During core molding, pressure may be applied while applying magnetic field. In some embodiments, by regulating the direction of the magnetic field and/or the degree of the magnetic field, the degree of orientation of the soft magnetic metal particles may be changed. For example, in some embodiments, by applying the magnetic field in a direction perpendicular to the compression direction, an absolute value of the degree of orientation of the soft magnetic metal particles included in the center core 6a1 may be increased.

Further, the center core 6a1 may be fired. By firing, the resin existing between the soft magnetic metal particles decomposes into inorganic material. Further, residual stress caused by core molding to the center core 6a1 tends to be reduced and/or permeability of the center core 6a1 tends to improve. Furthermore, the shape of the center core 6a1 is less likely to deform during the integration step described in below. As a result, by firing the center core 6a1, a coil component with high inductance L may be obtained. The reason that permeability of the center core 6a1 improves due to firing is because that a distance between the soft magnetic metal particles included in the center core 6a1 becomes smaller.

### (Base Core 6c1)

The base core 6c1 is prepared. A production method of the base core 6c1 is not particularly limited, and the production method of the center core 6a1 may be used. A soft magnetic metal powder used for the production of the base core 6c1 may be the same as or different from the soft magnetic metal powder used for the production of the center core 6a1. A resin used for the production of the base core 6c1 may be the same as or different from the resin used for the production of the center core 6a1.

### (Core Material)

A core material is not particularly limited. For example, it may be a mixture including the resin and the soft magnetic metal powder including soft magnetic metal particles. The soft magnetic metal powder used for the core material may be the same or different types of the soft magnetic metal powder used for the production of the center core. The soft magnetic metal powder used for the core material may be the same or different types of the soft magnetic metal powder used for the production of the base core. The resin used for the core material may be the same or different types of the resins used for the production of the center core. The resin used for the core material may be the same or different types of the resins used for the production of the base core. In the production method of the coil component according to one embodiment of the present disclosure, when the coil component having a predetermined inductance L is obtained, the larger the amount of resin included in the core material is, the less likely the short circuit occurs in the coil.

Further, a shape of the mixture of the resin and the soft magnetic metal powder including soft magnetic metal particles is not particularly limited. For example, it may be granules, or may be paste. When paste is formed, the mixture may be heated if needed.

### (Insert Member)

The coil is obtained by preparing an insert member including the coil part 4 formed by winding the conductor in a coil form. Both ends of the conductor 5 constituting the coil part 4 are pulled to the outside of the coil part 4 as the lead wire parts 5a and 5b. Terminals may be connected to the lead wire parts 5a and 5b after the main molding described in below. Terminals may be connected to the lead wire parts 5a and 5b in advance to main molding described in below. Connecting parts which connects the terminals and the lead wire parts 5a and 5b may be positioned outside of the exterior parts 6c and 6d; or may be positioned inside of the exterior parts 6c and 6d. The shape of the coil part 4 viewed from the winding axis direction is not limited to a circular shape. The shape of the coil part 4 viewed from the winding axis direction may be an oval shape, a rectangular shape, and so on.

### (Integration of Center Core, Base Core, Core Material, and Insert Member)

First, the base core 6c1 is inserted in the metal mold. Next, the insert member and the center core 6a1 are arranged at predetermined positions on the base core 6c1. At this time, the center core 6a1 is arranged so that the pressure applied direction of the above-mentioned center core 6a1 and the winding axis direction of the coil are perpendicular. Thereby, in the inductor 2 obtained at the end, the soft magnetic metal particles included in the first center pole part 6aa are oriented in the winding axis direction of the coil; and the average value of cos 2θ of the soft magnetic metal particles included in the first center pole part 6aa becomes a positive value. Also, the lead wire parts 5a and 5b may be connected with a lead frame.

Next, the core material is placed in the metal mold.

Next, main molding is carried out. Specifically, the base core 6c1, the center core 6a1, the insert member, and the core material which are inserted in the metal mold are pressurized. The pressure applied direction is along the winding axis direction of the coil. The coil and the core are press adhered by applying pressure, and these are integrated. Pressure of main molding is not particularly limited. For example, it may be within a range of 10 MPa to 600 MPa. In the case of obtaining the coil component having a predetermined inductance L, when the coil component is produced using the production method of the coil component according to one embodiment of the present disclosure, the pressure of main molding can be lowered compared to the case of producing the coil component using the method of main molding which applies pressure along the pressure applied direction of the center core production. As a result, the obtained coil component is less likely to have short circuit. Also, since it is possible to reduce the pressure of main molding, the metal mold can have longer lifetime.

Due to main molding, the base core 6c1, the center core 6a1, and the core material are integrally molded, and the core part 6 is obtained. That is, the core part 6 having the second center pole part 6ab and the exterior part 6d is obtained. Also, the soft magnetic metal particles included in the second center pole part 6ab and the exterior part 6d may be flattened to the direction of a plane perpendicular to the pressure applying direction. As a result, the soft magnetic metal particles included in the second center pole part 6ab and the exterior part 6d may be oriented to the direction perpendicular to the pressure applying direction (the winding axis direction of the coil). That is, the average value of cos 2θ of the soft magnetic metal particles included in the second center pole part 6ab and the exterior part 6d tend to easily become 0 or negative value.

During main molding, the center core 6a1 may slightly deform.

A temperature of main molding is not particularly limited, and main molding may be carried out at a temperature which softens the resin. As a method of molding for carrying out main molding at a temperature which softens the resin, a method which is generally known as warm molding, compression molding, and so on may be mentioned. In such case, each core, the insert member, and so on may be heated in advance (pre-heating). Also, a frame, punches, and so on of the metal mold may be heated as well.

The inductor 2 taken out of the mold, which is after main molding, may be heated to further cure the resin. The heating temperature at that time is not particularly limited. It may be within a range of 150° C. to 200° C.

The second center pole part Gab and the exterior part 6d are formed by main molding. In some embodiments, the soft magnetic metal particles included in the second center pole part 6ab and the exterior part 6d may be flattened to the direction of a plane perpendicular to the pressure applying direction. As a result, the soft magnetic metal particles included in the second center pole part 6ab and the exterior part 6d may be oriented to the direction perpendicular to the pressure applying direction (the winding axis direction of the coil). That is, the average value of cos 2θ of the soft magnetic metal particles included in the second center pole part 6ab and the exterior part 6d tend to easily become 0 or negative value.

### Second Embodiment

Hereinbelow, the second embodiment of the present disclosure is described, and the parts which are not particularly mentioned are basically the same as the first embodiment.

An inductor 2 which is one type of coil components according to the second embodiment of the present disclosure and the inductor 2 which is one type of coil components according to the first embodiment are produced by different production methods.

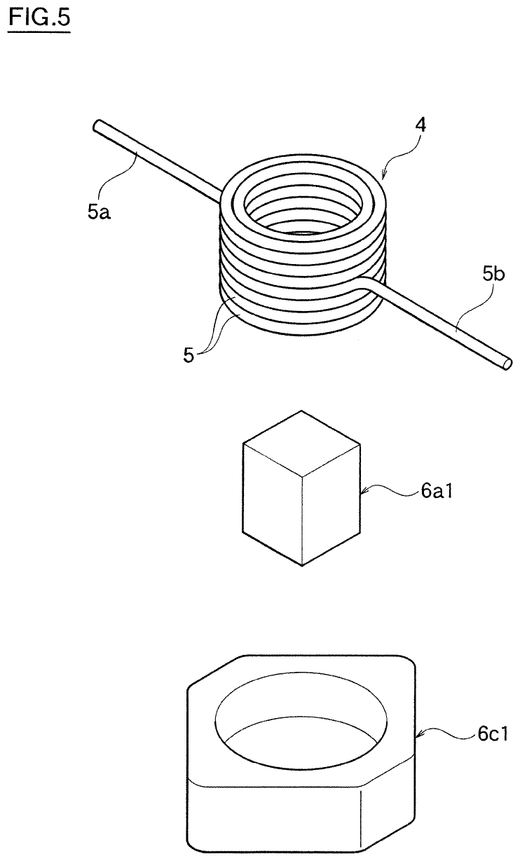

In the production method of the inductor 2 according to the first embodiment, the shape of the base core 6c1 is a flat plate shape as shown in FIG. 4. In the production method of the inductor 2 according to the second embodiment, the shape of the base core 6c1 is a pot shape as shown in FIG. 5. The production method of the inductor 2 according to the second embodiment is advantageous from the point that the position of the insert member is less likely to shift during main molding, and less likely to have cracks during main molding when aligning the heights of the pot-shaped base core 6c1 and the lead wire parts 5a and 5b.

### (Integrating Center Core, Base Core, Core Material, and Insert Member)

First, the pot-shaped base core 6c1 is inserted in the mold. Next, the insert member and the center core 6a1 are arranged at predetermined positions on the base core 6c1. At this time, the center core 6a1 is arranged so that the pressure applied direction of the above-mentioned center core 6a1 and the winding axis direction of the coil are perpendicular. Thereby, in the inductor 2 obtained at the end, the soft magnetic metal particles included in the first center pole part 6aa are oriented in the winding axis direction of the coil; and the average value of cos 2θ of the soft magnetic metal particles included in the first center pole part 6aa becomes positive value. Also, the lead wire parts 5a and 5b may be connected with a lead frame.

Next, the core material is placed in the mold.

Next, main molding (thermocompression bonding) is carried out. Specifically, the base core 6c1, the center core 6a1, the core material, and the insert member which are inserted in the mold are pressurized. The pressure applying direction is along the winding axis direction of the coil. The coil and the core are press adhered by applying pressure, and these are integrated. Pressure during main molding is not particularly limited. For example, it may be within a range of 10 MPa to 600 MPa.

The above-mentioned core material forms the second center pole part 6ab. The center core 6a1 and/or the base core 6c1 may partially deform, and thereby the second center pole part 6ab may be formed.

### Third Embodiment

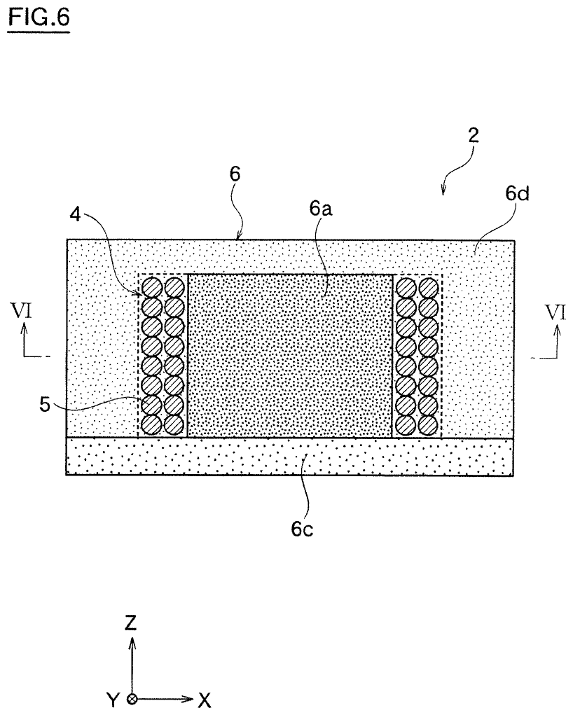

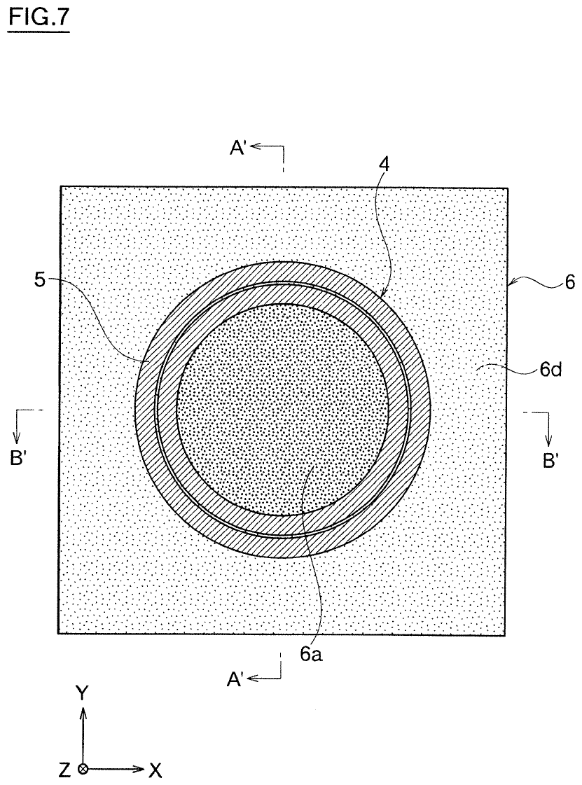

Hereinbelow, the third embodiment of the present disclosure is described, the parts which are not particularly mentioned are basically the same as the first embodiment. In the third embodiment, FIG. 1 and FIG. 2 of the first embodiment should be read as FIG. 6 and FIG. 7. Further, the line I-I should be read as a line VI-VI, the line A-A should be a line A′-A′, and the line B-B should be read as a line B′-B′.

As shown in FIG. 6, the core part 6 has the center pole part 6a and the exterior parts 6c and 6d which are positioned in the area surrounded by the inner diameter of the coil part 4. The center pole part 6a and/or the exterior parts 6c and 6d may be a green compact including the soft magnetic metal particles and the resin. That is, the core part 6 may include the green compact including the soft magnetic metal particles and the resin.

The center pole part 6a may have a uniform configuration or a non-uniform configuration. When the center pole part 6a has a non-uniform configuration, the center pole part 6a has parts with different contrasts in the case of observing by SEM and so on. Differences in contrasts may be caused by differences in materials of the soft magnetic metal particles included in each part, differences in the average aspect ratios, differences in the average degree of orientations, and/or differences in the filling densities. Also, the differences in contrasts may be caused by differences in types of resins and inorganic materials included in each part, and/or differences in the amounts of resins and inorganic materials included in each part.

In below description of the present disclosure, unless mentioned otherwise, the center pole part 6a has a uniform configuration.

The soft magnetic metal particles included in the center pole part 6a has an average value of cos 2θ of 0.1 or larger; and the soft magnetic metal particles included in the center pole part 6a has an average aspect ratio of 1.1 or larger. As each of the above-mentioned parameters are within the predetermined ranges, inductance of the coil component tends to improve easily. Also, even when the molding pressure during thermocompression bonding described in below is lowered, a high inductance may be obtained. By reducing the molding pressure, the load on the coil can also be reduced, and the coil is less likely to have short circuits. Further, it becomes easier to design a coil component with low coil resistance and also easier to design a downsized coil component.

The average degree of orientation of the soft magnetic metal particles included in the center pole part 6a may be larger than an average degree of orientation of the soft magnetic particles included in areas other than center pole part 6a, particularly in the area outside of the coil part 4. Specifically, when θ is the deflection angle of the soft magnetic metal particle against the winding axis direction of the coil part 4, the average value of cos 2θ of the soft magnetic metal particles included in the center pole part 6a may be larger than the average value of cos 2θ of the soft magnetic metal particles included in the area outside of the coil part 4 viewing from the winding axis of the coil. The degree of orientation in the present disclosure refers to the degree of orientation to the winding axis direction of the coil part 4.

The average value of cos 2θ of the soft magnetic metal particles included in the center pole part 6a may be 0.1 or larger, 0.5 or larger, or 1.0.

The average aspect ratio of the soft magnetic metal particles included in the center pole part 6a may be 1.1 or larger, within a range of 1.1 or larger and 5.0 or smaller, or within a range of 1.5 or larger and 5.0 or smaller.

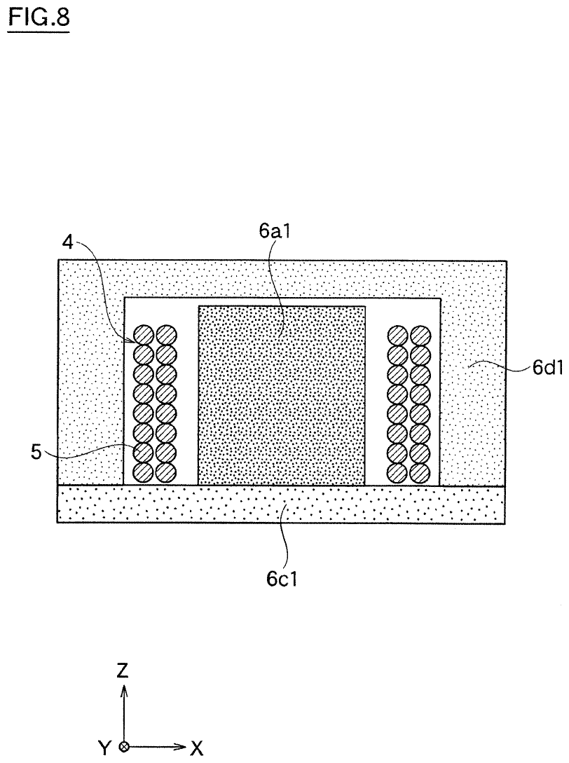

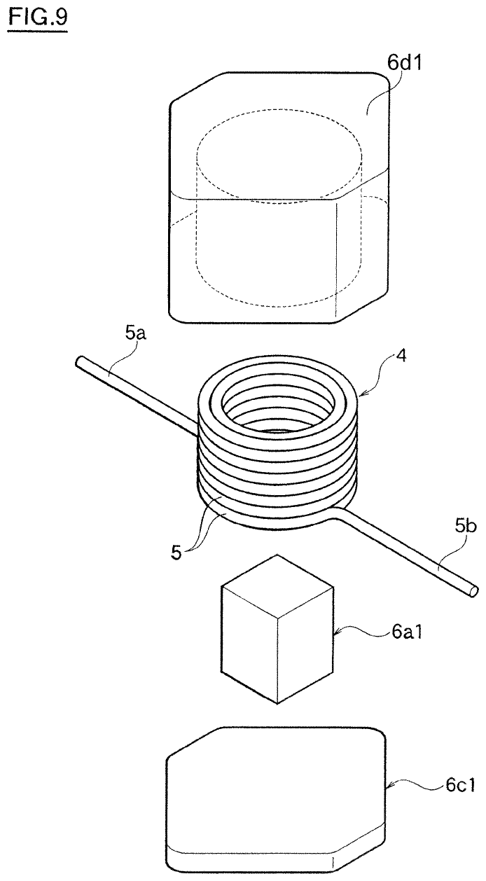

Next, a production method of the inductor 2 shown in FIG. 6 is explained using FIG. 8 and FIG. 9.

As shown in FIG. 8 and FIG. 9, the inductor 2 produced using the production method of the inductor 2 according to the third embodiment of the present disclosure is produced by integrating the center core 6a1 which mainly becomes the center pole part 6a at the end, the base core 6c1 which mainly becomes the exterior part 6c at the end, the cover core 6d1 which mainly becomes the exterior part 6d at the end, and the insert member including the coil part 4 constituted by an air core coil and so on. Also, the core material (not shown in the figures) which mainly becomes the center pole part 6a and/or the exterior part 6d at the end may be used as well.

As shown in FIG. 8, a length of the center core 6a1 in Z-axis direction is longer than a length of the coil part 4 in Z-axis direction. The portion which overflew is pressed by the cover core 6d1 during thermocompression bonding adhesion, then deforms and moves into the center pole part 6a, thereby the center pole part 6a is filled.

### (Center Core 6a1)

As the material of the center core 6a1, the resin and the soft magnetic metal powder including soft magnetic metal particles are prepared. In below, the steps up to producing the granules are the same as the first embodiment.

Next, the center core 6a1 is prepared using compression molding. Specifically, a mold is filled with the obtained granules, then pressure is applied, thereby the center core 6a1 is obtained. At this time, the soft magnetic metal particles deform, and the soft magnetic metal particles are flattened in the direction of a plane perpendicular to the pressure applying direction. As a result, the soft magnetic metal particles are oriented in a direction perpendicular to the pressure applying direction. In below, preparation of the center core 6a1 by compression molding may be referred to as first molding. Also, the center core 6a1 prepared by compression molding is a green compact including the soft magnetic metal particles and the resin.

The applied pressure during compression is not particularly limited, and the higher the pressure is, the flatter the soft magnetic metal particles tend to be. For example, it may be within a range of 400 MPa to 1000 MPa.

During first molding, pressure may be applied while applying magnetic field. In some embodiments, the degree of orientation of the soft magnetic metal particles may be changed by controlling the applied direction of the magnetic field and/or by the degree of the magnetic field. For example, by applying the magnetic field in a direction perpendicular to the compression direction, the absolute value of the degree of orientation of the soft magnetic metal particles included in the center core 6a1 can be larger.

### (Base Core 6c1)

The base core 6c1 is prepared. The production method of the bae core 6c1 is the same as the first embodiment.

### (Cover Core 6d1)

The pot-shaped cover core 6d1 is prepared. The production method of the cover core 6d1 is not particularly limited, and it may be the same as the production method of the center core 6a1. The soft magnetic metal powder used for the production of the cover core 6d1 may be the same type or different types of the soft magnetic metal powder used for the production of the center core 6a1. The resin used for the production of the cover core 6d1 may be the same type or different types of the resin used for the production of the center core 6a1. The larger the amount of the resin included in the cover core 6d1 is, the less likely it is for the coil to have short circuit in the case of obtaining the coil component having a predetermined inductance L.

### (Core Material)

When using the core material, the type of core material is not particularly limited, and it may be the same as the first embodiment. The base core of the first embodiment may be read as the cover core accordingly.

### (Insert Member)

The insert member having the coil part 4 is formed by winding a conductor in a coil form as the same in the case of first embodiment.

### (Integrating Center Core, Base Core, Cover Core, and Insert Member)

First, the base core 6c1 is inserted into the mold. Next, as shown in FIG. 8, the insert member and the center core 6a1 are arranged to the predetermined position on the base core 6c1. At this time, the center core 6a1 is arranged so that the pressure applied direction of the above-mentioned center core 6a1 and the winding axis direction of the coil are perpendicular to each other. By doing so, the soft magnetic metal particles included in the center pole part 6a of the inductor 2 obtained at the end are oriented along the winding axis direction of the coil, and the average value of cos 2θ of the soft magnetic metal particles included in the center core 6a becomes a positive value. Also, the lead wire parts 5a and 5b may be connected to the lead frame.

Next, as shown in FIG. 8, the cover core 6d1 is inserted in the mold, and placed at the predetermined position on the insert member and on the center core 6a1. The core material may be placed in the mold accordingly before inserting the cover core 6d1 in the mold, however in below description, the core material is not placed in the mold.

Next, molding is carried out using thermocompression bonding. Specifically, each core inserted in the mold is heated to the temperature at which the resin softens, then the base core 6c1, the center core 6a1, the cover core 6d1, and the insert member are thermocompressed. Each core, the insert member, and so on may be heated in advance (pre-heating). Also, the frame of the mold, punches, and so on may be heated. The pressure applying direction is along the winding axis direction of the coil. The coil and the core are thermocompressed by applying pressure, and these are integrated. Each core deforms by thermocompression bonding, and particularly the center core 6a1 deforms into a circular columnar shape. The space between the center core 6a1 and the insert member is filled with the center core 6a1. Pressure during thermocompression bonding is not particularly limited. For example, it may be within a range of 100 MPa to 400 MPa. Temperature during thermocompression bonding is not particularly limited. For example, it may be within a range of 50° C. to 100° C. In the case of obtaining the coil component having a predetermined inductance L, when the coil component is produced using the production method of a coil component according to one embodiment of the present disclosure, pressure during thermocompression bonding can be lowered compared to the case of heat compressing by applying the pressure along the direction of pressure which is applied during the production of the center core. As a result, the coil component obtained is less likely to have short circuits. Also, it is possible to achieve longer lifetime of the mold. In below, molding for integrating each member such as the center core 6a1 may be referred to as second molding. Second molding may be carried out using a method other than thermocompression bonding. In below description, second molding is carried out using thermocompression bonding.

The base core 6c1, the center core 6a1, and the cover core 6d1 are integrally molded by thermocompression bonding, thereby the core part 6 is obtained. That is, the core part 6 having the center pole part 6a and the exterior parts 6c and 6d is obtained. Also, the soft magnetic metal particles included in the exterior parts 6c and 6d may be flattened in a direction of plane perpendicular to the pressure applying direction. As a result, the soft magnetic metal particles included in the exterior parts 6c and 6d may orient in the direction perpendicular to the pressure applying direction (the winding axis direction of the coil). That is, the average value of cos 2θ of the soft magnetic metal particles included in the exterior part 6d tends to easily be 0 or negative value.

The inductor 2 taken out from the mold after the thermocompression bonding may be heated to further cure the resin. The heating temperature for this heat treatment is not particularly limited. For example, it may be within a range of 150° C. to 200° C.

### Fourth Embodiment

In below, the fourth embodiment of the present disclosure is described, and the parts which are not particularly mentioned are basically the same as the third embodiment.

An inductor 2 which is one type of coil components according to the fourth embodiment of the present disclosure and the inductor 2 which is one type of the coil components according to the third embodiment are produced using different production method.

A production method of the inductor 2 according to the fourth embodiment does not use a cover core. As shown in FIG. 5, the inductor 2 is produced by integrating the center core 6a1, the pot-shaped base core 6c1, the core material (not shown in the figure), and the insert member having the coil 4 constituted of an air coil and so on.

The length of the center core 6a1 in Z-axis direction may be the same as the length of the coil part 4 in Z-axis direction, may be longer than the length of the coil part 4 in Z-axis direction, or may be shorter than the length of the coil part 4 in Z-axis direction. The length of the pot-shaped base core 6c1 and so on in the winding axis direction may be adjusted accordingly.

### (Integrating Center Core, Base Core, Core Material, and Insert Member)

First, the pot-shaped base core 6c1 is inserted in the mold. Next, the insert member and the center core 6a1 are arranged at the predetermined position on the base core 6c1. At this time, the center core 6a1 is arranged so that the pressure applied direction of the above-mentioned center core 6a1 and the winding axis direction of the coil are perpendicular to each other. Thereby, in the inductor 2 obtained at the end, among the soft magnetic metal particles included in the center pole part 6a, the soft magnetic metal particles from the center core 6a1 are oriented in the winding axis direction of the coil; and the average value of cos 2θ of the soft magnetic metal particles included in the center pole part 6a becomes a positive value. Also, the lead wire parts 5a and 5b may be connected with a lead frame.

Next, the core material is placed in the metal mold.

Next, second molding is carried out. Specifically, the pot-shaped base core 6c1, the center core 6a1, the insert member, and the core material which are inserted in the mold are pressurized. The pressure applying direction is along the winding axis direction of the coil. The coil and the core are press adhered by applying pressure, and these are integrated. Pressure during second molding is not particularly limited. For example, it may be within a range of 10 MPa to 600 MPa. The higher the pressure of second molding is, the easier the inductance L of the coil component tends to improve, but it is more likely to have short circuits in the coil. Also, the lifetime of the mold tends to become shorter.

The space between the center core 6a1 and the insert member prior to the second molding is filled with the core material, and the pot-shaped base core 6c1, the center core 6a1, and the core material are integrally molded, thereby the core part 6 is obtained. That is, the core part 6 having the center pole part 6a and the exterior parts 6c and 6d is obtained by second molding. The center core 6a1 may be deformed while molding, and the space between the center core 6a1 and the insert member before molding may be filled with a part of deformed center core 6a1.

The temperature during second molding is not particularly limited, and second molding may be carried out at the temperature which softens the resin. A molding method of carrying out second molding at the temperature which softens the resin is a molding method generally called as a warm molding method, a compression molding method, and so on. In this case, each core, the insert member, and so on may be heated in advance (pre-heating). Also, the frame of the mold, punches, and so on may be heated.

The inductor 2 which has been taken out of the mold after second molding may be heated to further cure the resin. The heating temperature at that time is not particularly limited. It may be within a range of 150° C. to 200° C.

The inductor 2 obtained in the fourth embodiment has the center pole part 6a having a non-uniform configuration. Specifically, the area mainly derived from the center core 6a1 and the area mainly derived from the core material have different degrees of orientation of the soft magnetic metal particles and different aspect ratios of the soft magnetic metal particles. The degree of orientation of the soft magnetic metal particles and the average aspect ratio of the soft magnetic metal particles included in the center pole part 6a are measured by appropriately setting the position of the observation area, and the number of soft magnetic metal particles to be observed.

### Other Embodiments

The production method of the inductor 2 according to the present disclosure is not limited to the above-mentioned methods. Particularly regarding the shape and number of the core are not particularly limited as long as the inductor 2 shown in FIG. 1 or FIG. 6 can be obtained at the end. Also, the coil component of other embodiments may be a mold integrated coil component as shown in the first embodiment to fourth embodiment; that is, it may be a coil component of which the whole coil component except for the lead wire part of the conductor is sealed by a magnetic body.

In the above-mentioned first and second embodiments, the center core 6a1 is arranged so that the pressure applied direction of the center core 6a1 and the winding axis direction of the coil are perpendicular to each other, however, the center core 6a1 does not necessarily have to be arranged in this way. In some embodiments, the soft magnetic metal particles included in the center core 6a1 may be oriented along the pressure applying direction by applying magnetic field along the pressure applying direction during molding of the center core 6a1. In this case, the center core 6a1 may be arranged so that the pressure applied direction of the center core 6a1 and the winding axis direction of the coil are parallel to each other.

Regarding the third embodiment, for example, the base core 6c1 may be pot shaped which is the same as the cover core 6d1. In this case, the length of the pot-shaped base core 6c1 in the winding axis direction, the length of the cover core 6d1 in the winding axis direction, and the positions of the lead wire parts 5a and 5b are adjusted accordingly. Part of the base core 6c1 may be deformed by second molding and it may fill the gap between the insert member and the center core 6a1. Also, the base core 6c1 and/or the cover core 6d1 may be a flat plate form, and other core may be inserted between the base core 6c1 and the cover core 6d1.

In the above-mentioned fourth embodiment, the base core 6c1 may be a flat plate shape. In such case, the positions of the lead wire parts 5a and 5b are adjusted accordingly. The center core 6a1 is arranged so that the pressure applied direction of the center core 6a1 and the winding axis direction of the coil are perpendicular to each other, however, the center core 6a1 does not necessarily have to be arranged in this way. In some embodiments, by applying magnetic field along the direction of pressure applied to the center core 6a1 during molding (during first molding), the soft magnetic metal particles included in the center core 6a1 may be oriented along the pressure applied direction. In this case, the center core 6a1 may be arranged so that the pressure applied direction of the center core 6a1 and the winding axis direction of the coil are parallel to each other.

The coil component according to the present disclosure is not limited to an inductor. For example, it may be a coil component such as a transformer, a reactor, and so on. However, the coil component according to the present disclosure may be particularly good as an inductor, considering the fact that the coil component according to the present disclosure tends to easily improve inductance and also considering the fact that integral molding is difficult for a transformer, a reactor, and so on.

### EXAMPLES

Hereinbelow, the present disclosure is described in further detail using examples, however, the present disclosure is not limited thereto.

### Experiment Example 1

A production method of an inductor sample of each example (Sample Nos. 2 to 4, 6 to 8, 10 to 12, and 14 to 16) shown in FIG. 1 is described.

First, a center core, a base core, an insert member, and a core material were prepared.

### (Center Core)

A resin and a soft magnetic metal powder including soft magnetic metal particles were prepared as materials of the center core. The material of the soft magnetic metal particle was Fe—Si alloy (Fe 95.5 wt %, Si 4.5 wt %), and a Vickers hardness of the soft magnetic metal particles was 300 HV. An average particle size of the soft magnetic metal powder was 25 μm, and an epoxy resin was used as the resin.

Next, insulation coating layers were formed on the surfaces of the soft magnetic metal particles. Specifically, a SiO₂ layer was formed as the insulation coating layer using a sol-gel method. A thickness of the insulation coating layer was about 40 nm or so.

Next, the soft magnetic metal powder and the resin were mixed and granulated to obtain granules. Specifically, after the resin was added to and stirred with the soft magnetic metal powder, it was dried at 40° C. for 10 hours. An amount ratio of the resin was 2 to 3 parts by weight to 100 parts by weight of the soft magnetic metal powder. The type of the resin was an epoxy resin. After the resin was added to and stirred with the soft magnetic metal powder, it was passed through a mesh to remove coarse granules. Specifically, it was passed through a mesh having opening of 100 μm. The granules obtained at the end had an average particle size of 60 μm or so.

Next, the obtained granules were placed in the mold, and by carrying out core molding, a center core of a quadrangular prism shape shown in FIG. 4 was obtained. The dimension of the center core was 1.0 mm×1.1 mm×1.0 mm. At this time, the soft magnetic metal particles were deformed, and were flattened to the direction of a plane perpendicular to the pressure applying direction. As a result, the soft magnetic metal particles were oriented in the direction perpendicular to the pressure applying direction. Molding pressure was within a range of 400 to 1000 MPa.

When an average aspect ratio of a first center pole part of an inductor sample obtained at the end was 5.0 and a degree of orientation (Φ1) of the first center pole part was 1.0, a flattening treatment was carried out before the soft magnetic metal powder and the resin were mixed. Specifically, IPA was added as a solvent to the soft magnetic metal powder to form a slurry, then the soft magnetic metal particles included in the soft magnetic metal powder was pulverized using a bead mill which is a wet pulverizer. After pulverization, IPA was removed by drying using a spray drier. Further, zinc stearate as a lubricant was added to the granules. An added amount of zinc stearate was 0.2 parts by weight or less with respect to 100 parts by weight of the granules. Further, core molding of the center core was carried out using a warm molding method. Specifically, core molding of the center core was carried out while heating the mold and the granules. Heating was carried out at a heating temperature around the softening point of the resin. Further, the center core was core molded while applying magnetic field in a direction perpendicular to the pressure applying direction.

When the aspect ratio of the first center pole part was to be smaller than 5.0, whether or not to carry out the flattening treatment, the condition of the flattening treatment, the molding pressure during core molding, the hardness of the soft magnetic metal powder, the hardness of the resin, and so on were controlled accordingly. Specifically, as the conditions of the flattening treatment, a pulverization time, a rotational speed of the pulverizer, a concentration of the slurry, a viscosity of the slurry, and so on were controlled accordingly.

When the degree of orientation of the first center pole part was to be smaller than 1.0, whether or not to apply the magnetic field, whether or not to heat during core molding, the temperature of heating, whether or not to add the lubricant, the added amount of the lubricant, and so on were controlled accordingly.

### (Base Core)

A production method of the base core was the same as the production method of the center core.

### (Insert Member)

An insert member having the coil part 4 shown in FIG. 4 was prepared. The size of the coil part 4 was an inner diameter of 1.5 mm, a height of 1.0 mm, and the material of the coil part 4 was Cu.

### (Core Material)

As the core material, the resin and the soft magnetic metal powder including soft magnetic metal particles were prepared. The material of the soft magnetic metal particle was Fe—Si alloy (Fe 95.5 wt %, Si 4.5 wt %), and a Vickers hardness of the soft magnetic metal particles was 300 HV. An average particle size of the soft magnetic metal powder was 25 μm. An epoxy resin was used as the resin.

Next, insulation coating layers were formed on the surfaces of the soft magnetic metal particles. Specifically, a SiO₂ layer was formed as the insulation coating layer using a sol-gel method. A thickness of the insulation coating layer was about 40 nm or so.

Next, the soft magnetic metal powder and the resin were mixed and granulated to obtain granules. Specifically, after the resin was added to and stirred with the soft magnetic metal powder, and it was dried at 40° C. for 10 hours. An amount ratio of the resin was as shown in Table 1. The type of the resin was an epoxy resin. After the resin was added to and stirred with the soft magnetic metal powder, it was passed through a mesh to remove coarse granules. Specifically, it was passed through a mesh having opening of 100 μm. The granules obtained at the end had an average particle size of 60 μm or so.

(Integrating Center Core, Base Core, Core Material, Insert member)

First, the base core was inserted in the mold. Next, as shown in FIG. 4, the insert member and the center core were arranged at the predetermined position on the base core. The arrangement direction of the center core at this point is shown in Table 1. When the pressure applied direction of the center core and the winding axis direction of the coil were perpendicular to each other, then it was indicated “perpendicular”; and when the pressure applied direction of the center core and the winding axis direction of the coil were parallel to each other, then it was indicated “parallel”. When it was indicated “perpendicular”, the center core was arranged in a direction that the side with length of 1.1 mm was the height direction.

Next, the core material was placed in the mold.

Next, molding was carried out. Specifically, the base core, the center core, the insert member, and the core material which were placed in the mold were pressurized. The pressure applying direction was along the winding axis direction. The coil and the core were pressure adhered by applying pressure, and these were integrated. Molding pressure during molding was as shown in Table 1. Molding was carried out at roughly the temperature around the softening temperature of the resin.

The inductor 2 was taken out from the mold after molding, and heating was carried out to cure the resin. The heating temperature was within a range of 150 to 200° C., and the heating time was within a range of 1 to 3 hours.

In below, an inductor shown in FIG. 1 was obtained. A dimension of the inductor was 3 mm×3 mm×2 mm, in which 2 mm was the height.

Sample No. 1 which is a comparative example shown in Table 1 was carried out under the same conditions as Sample Nos. 2 to 4 except that Sample No. 1 did not have a center core.

Sample Nos. 5, 9, and 13 which are comparative examples shown in Table 1 were carried out in the same manner as other examples except that the shapes of the center cores were a circular columnar shape which was the same shape as the center pole part of the coil part for the sample Nos. 5, 9, and 13.

In the center pole part of the inductor of each comparative example, the first center pole part and the second center pole part were not differentiated. In Table 1, for convenience, as an aspect ratio of the first center pole part and a degree of orientation of the first center pole part, an aspect ratio of the center pole part and the degree of orientation of the center pole part are shown.

For the obtained inductor, an aspect ratio of the soft magnetic metal particles included in the first center pole part, an average degree of orientation Φ1 of the soft magnetic metal particles included in the first center pole part, an average degree of orientation Φ2 of the soft magnetic metal particles included in the second center pole part, and an average degree of orientation Φ3 of the soft magnetic metal particles included in the exterior part were measured.

Specifically, first, the inductor of each sample was cut along the part which corresponds to a line I-I of FIG. 1. The obtained cross section was cut along the part corresponding to a line A-A and the part corresponding to a line B-B shown in FIG. 2. The cross section along the line A-A was observed using a generally used image analysis device, and a cross section image along the line A-A was obtained. Further, the cross section along the line B-B was observed, and the cross-section image along the line B-B was obtained.

For each cross-section image, an average aspect ratio of the soft magnetic metal particles included in the first center pole part was measured. Among the obtained average aspect ratios from each cross-section image, the larger aspect ratio was defined as the average aspect ratio of the soft magnetic metal particles included in the first center pole part. Further, using the cross-section image having the larger aspect ratio, Φ1, Φ2, and Φ3 were measured. Each of these were as shown in Table 1. In each example, the average degree of orientation Φ1 of the soft magnetic metal particles included in the first center pole part was higher than the average degree of orientation Φ2 of the soft magnetic metal particles included in the second center pole part. Further, the average degree of orientation Φ1 of the soft magnetic metal particles included in the first center pole part was higher than the average degree of orientation Φ3 of the soft magnetic metals included in the exterior part.

Regarding the obtained inductor, inductance L was measured. For measuring inductance, an RF impedance material analyzer (4491A made by Agilent) was used under the conditions of measuring frequency of 1 MHz and a measuring voltage of 500 mV. Results are shown in Table 1. When inductance was 0.90 μH or larger, it was considered good.

Regarding the obtained inductor, an ESD test (Electrostatic Discharge test) which is in accordance with JEITA ED-4701/302A by HBM (Human Body Model) was carried out. Testing voltage was 2 kV. Table 1 shows whether the sample passed ESD test.

Regarding the obtained inductor, an impulse breakdown voltage test (impulse BDV test) was carried out. The impulse BDV test was carried out using an impulse winding tester (19301A made by Chroma) under impulse winding test breakdown voltage mode (IWT BDV MODE). Specifically, AC pulse signal with a predetermined maximum amplitude was input to a sample (inductor) to measure a standard pulse wave. Next, an evaluation pulse signal was input, and a pulse wave detected in response to the evaluation pulse signal was obtained. The pulse signal was obtained by gradually increasing the measuring voltage. When an area of the pulse wave was smaller than 2.0% of an area of a standard pulse wave, the measuring voltage at this point was defined as a breakdown voltage. That is, when the area of the obtained pulse wave was smaller than 2.0% of the area of a standard pulse wave, it was determined that short circuit had occurred between the conductors of the coil part. The measuring voltage was within a range of 50 V to 350 V (a measuring voltage step: 1%), a number of pulse application was 1. In Table 1, when breakdown did not occur at the measuring voltage of 350 V, that is, when the breakdown voltage was larger than 350 V, it was indicated “pass”; and when breakdown occurred at the measuring voltage of 350 V or lower, that is, when the breakdown voltage was 350 V or lower, then it was indicated “short”.

TABLE 1

| | | | | Aspect | | | | Resin | | | | |
|---|---|---|---|---|---|---|---|---|---|---|---|---|
| | | | | ratio | Φ 1 of | Φ 2 of | | amount | Pressure | | | Impulse test |
| | Example/ | | Center core | of first | first | second | Φ 3 of | of core | of main | | ESD test | Breakdown |
| Sample | Comparative | Shape of | arranged | center | center | center | exterior | material | molding | L | HBM ± | voltage > |
| No. | example | center core | direction | part | part | part | part | [wt %] | [MPa] | [μH] | 2 kV | 350 V |
| 1 | Comparative | [symbol] | [symbol] | 1.1 | [symbol] | [symbol] | 0.0 | 2.4 | 400 | [symbol] | Pass | Pass |
| | example | | | | | | | | | | | |
| 2 | Example | Square | Perpendicular | 1.1 | 0.1 | 0.0 | 0.0 | 2.4 | 400 | 0.91 | Pass | Pass |
| | | prism shape | | | | | | | | | | |
| 3 | Example | Square | Perpendicular | 1.1 | 0.5 | 0.0 | 0.0 | 2.4 | 400 | 0.92 | Pass | Pass |
| | | prism shape | | | | | | | | | | |
| 4 | Example | Square | Perpendicular | 1.1 | 1.0 | 0.0 | 0.0 | 2.4 | 400 | 0.93 | Pass | Pass |
| | | prism shape | | | | | | | | | | |
| 5 | Comparative | [symbol] | [symbol] | 1.5 | [symbol] | [symbol] | 0.0 | 2.4 | 400 | [symbol] | Pass | Pass |
| | example | [symbol] | | | | | | | | | | |
| | | [symbol] | | | | | | | | | | |
| 6 | Example | Square | Perpendicular | 1.5 | 0.1 | 0.0 | 0.0 | 2.4 | 400 | 0.92 | Pass | Pass |
| | | prism shape | | | | | | | | | | |
| 7 | Example | Square | Perpendicular | 1.5 | 0.5 | 0.0 | 0.0 | 2.4 | 400 | 0.94 | Pass | Pass |
| | | prism shape | | | | | | | | | | |
| 8 | Example | Square | Perpendicular | 1.5 | 1.0 | 0.0 | 0.0 | 2.4 | 400 | 0.96 | Pass | Pass |
| | | prism shape | | | | | | | | | | |
| 9 | Comparative | [symbol] | [symbol] | 3.0 | [symbol] | [symbol] | 0.0 | 2.4 | 400 | [symbol] | Pass | Pass |
| | example | [symbol] | | | | | | | | | | |
| | | [symbol] | | | | | | | | | | |
| 10 | Example | Square | Perpendicular | 3.0 | 0.1 | 0.0 | 0.0 | 2.4 | 400 | 0.93 | Pass | Pass |
| | | prism shape | | | | | | | | | | |
| 11 | Example | Square | Perpendicular | 3.0 | 0.5 | 0.0 | 0.0 | 2.4 | 400 | 0.97 | Pass | Pass |
| | | prism shape | | | | | | | | | | |
| 12 | Example | Square | Perpendicular | 3.0 | 1.0 | 0.0 | 0.0 | 2.4 | 400 | 1.03 | Pass | Pass |
| | | prism shape | | | | | | | | | | |
| 13 | Comparative | [symbol] | [symbol] | 5.0 | [symbol] | [symbol] | 0.0 | 2.4 | 400 | [symbol] | Pass | Pass |
| | example | [symbol] | | | | | | | | | | |
| | | [symbol] | | | | | | | | | | |
| 14 | Example | Square | Perpendicular | 5.0 | 0.1 | 0.0 | 0.0 | 2.4 | 400 | 0.94 | Pass | Pass |
| | | prism shape | | | | | | | | | | |
| 15 | Example | Square | Perpendicular | 5.0 | 0.5 | 0.0 | 0.0 | 2.4 | 400 | 1.00 | Pass | Pass |
| | | prism shape | | | | | | | | | | |
| 16 | Example | Square | Perpendicular | 5.0 | 1.0 | 0.0 | 0.0 | 2.4 | 400 | 1.09 | Pass | Pass |
| | | prism shape | | | | | | | | | | |

Each example having the first center pole part of a quadrangular prism shape had high inductance L.

### Experiment Example 2

Experiment example 2 was different from Experiment example 1, since in Experiment example 2, the resin amount of the core material and a molding pressure during main molding were regulated so that inductance L was 0.90 μH. Other than these, Experiment example 2 was carried out under the same conditions as Experiment example 1. Results are shown in Table 2.

TABLE 2

| | | | | Aspect | | | | Resin | | | | |
|---|---|---|---|---|---|---|---|---|---|---|---|---|
| | | | | ratio | Φ 1 of | Φ 2 of | | amount | Pressure | | | Impulse test |
| | Example/ | | Center core | of first | first | second | Φ 3 of | of core | of main | | ESD test | Breakdown |
| Sample | Comparative | Shape of | arranged | center | center | center | exterior | material | molding | L | HBM ± | voltage > |
| No. | example | center core | direction | part | part | part | part | [wt % ] | [MPa] | [μH] | 2 kV | 350 V |
| 101 | Comparative | [symbol] | [symbol] | 1.1 | [symbol] | [symbol] | 0.0 | 2.1 | 510 | 0.90 | [symbol] | [symbol] |
| | example | | | | | | | | | | | |
| 102 | Example | Square | Perpendicular | 1.1 | 0.1 | 0.0 | 0.0 | 2.4 | 420 | 0.90 | Pass | Pass |
| | | prism shape | | | | | | | | | | |
| 103 | Example | Square | Perpendicular | 1.1 | 0.5 | 0.0 | 0.0 | 2.4 | 420 | 0.90 | Pass | Pass |
| | | prism shape | | | | | | | | | | |
| 104 | Example | Square | Perpendicular | 1.1 | 1.0 | 0.0 | 0.0 | 2.7 | 410 | 0.90 | Pass | Pass |
| | | prism shape | | | | | | | | | | |
| 105 | Comparative | [symbol] | [symbol] | 1.5 | [symbol] | [symbol] | 0.0 | 2.4 | 450 | 0.90 | Pass | [symbol] |
| | example | [symbol] | | | | | | | | | | |
| | | [symbol] | | | | | | | | | | |
| 106 | Example | Square | Perpendicular | 1.5 | 0.1 | 0.0 | 0.0 | 2.4 | 420 | 0.90 | Pass | Pass |
| | | prism shape | | | | | | | | | | |
| 107 | Example | Square | Perpendicular | 1.5 | 0.5 | 0.0 | 0.0 | 2.7 | 400 | 0.90 | Pass | Pass |
| | | prism shape | | | | | | | | | | |
| 108 | Example | Square | Perpendicular | 1.5 | 1.0 | 0.0 | 0.0 | 2.7 | 370 | 0.90 | Pass | Pass |
| | | prism shape | | | | | | | | | | |
| 109 | Comparative | [symbol] | [symbol] | 3.0 | [symbol] | [symbol] | 0.0 | 2.1 | 470 | 0.90 | [symbol] | [symbol] |
| | example | [symbol] | | | | | | | | | | |
| | | [symbol] | | | | | | | | | | |
| 110 | Example | Square | Perpendicular | 3.0 | 0.1 | 0.0 | 0.0 | 2.7 | 400 | 0.90 | Pass | Pass |
| | | prism shape | | | | | | | | | | |
| 111 | Example | Square | Perpendicular | 3.0 | 0.5 | 0.0 | 0.0 | 2.7 | 350 | 0.90 | Pass | Pass |
| | | prism shape | | | | | | | | | | |
| 112 | Example | Square | Perpendicular | 3.0 | 1.0 | 0.0 | 0.0 | 3.0 | 280 | 0.90 | Pass | Pass |
| | | prism shape | | | | | | | | | | |
| 113 | Comparative | [symbol] | [symbol] | 5.0 | [symbol] | [symbol] | 0.0 | 2.1 | 530 | 0.90 | [symbol] | [symbol] |
| | example | [symbol] | | | | | | | | | | |
| | | [symbol] | | | | | | | | | | |
| 114 | Example | Square | Perpendicular | 5.0 | 0.1 | 0.0 | 0.0 | 2.7 | 390 | 0.90 | Pass | Pass |
| | | prism shape | | | | | | | | | | |
| 115 | Example | Square | Perpendicular | 5.0 | 0.5 | 0.0 | 0.0 | 3.0 | 320 | 0.90 | Pass | Pass |
| | | prism shape | | | | | | | | | | |
| 116 | Example | Square | Perpendicular | 5.0 | 1.0 | 0.0 | 0.0 | 3.0 | 210 | 0.90 | Pass | pass |
| | | prism shape | | | | | | | | | | |

When the production condition was controlled so to obtain the same inductance L from each example having a first center pole part of a quadrangular prism shape and from each comparative example having a first center pole part which is not quadrangular prism shape, the result of ESD test and/or the result of inductance test from comparative examples deteriorated. It is thought that the deterioration occurred in the comparative examples, since the resin amount in the core material was low and the pressure during main molding was large.

Each example having the first center pole part of a quadrangular prism shape was able to maintain a high inductance L even when the resin was increased in the area other than the first center pole part of the quadrangular prism shape, or even when the pressure during main molding was decreased. That is, load to the coil during the production of the coil was reduced while maintaining a high inductance.

### Experiment Example 3

A production method of an inductor sample of each example and each comparative example (except for Sample No. 201) shown in Table 3 is described.

First, the center core, the base core, the pot-shaped cover core, and the insert member were prepared.

### (Center Core)

As a material of the center core, the resin and the soft magnetic metal powder including soft magnetic metal particles were prepared. The material of the soft magnetic metal particles was Fe—Si alloy (Fe 95.5 wt %, Si 4.5 wt %), and hardness of the soft magnetic metal particles was 300 HV. An average particle size of the soft magnetic metal powder was 25 μm. An epoxy resin was used as the resin.

Next, insulation coating layers were formed on the surfaces of the soft magnetic metal particles. Specifically, a SiO₂ layer was formed as the insulation coating layer using a sol-gel method. A thickness of the insulation coating layer was about 40 nm or so.

Next, the soft magnetic metal powder and the resin were mixed and granulated to obtain granules. Specifically, after the resin was added to and stirred with the soft magnetic metal powder, it was dried at 40° C. for 10 hours. An amount ratio of the resin was within a range of 2 to 3 parts by weight to 100 parts by weight of the amount ratio of the soft magnetic metal powder. The type of the resin was an epoxy resin. After the resin was added to and stirred with the soft magnetic metal powder, it was passed through a mesh to remove coarse granules. Specifically, it was passed through a mesh having opening of 100 μm. The granules obtained at the end had an average particle size of 60 μm or so.

Next, the obtained granules were placed in the mold, and by carrying out core molding, a center core of a quadrangular prism shape shown in FIG. 9 was obtained. The dimension of the center core was 1.0 mm×1.0 mm×1.5 mm. At this time, the soft magnetic metal particles were deformed, and were flattened to the direction of a plane perpendicular to the pressure applying direction. As a result, the soft magnetic metal particles were oriented in the direction perpendicular to the pressure applying direction. Molding pressure was within a range of 400 to 1000 MPa. The center core used in examples and the center core used in comparative examples had different pressure applying direction.

When an average aspect ratio of a first center pole part of an inductor sample obtained at the end was 5.0 and a degree of orientation (Φ1) of the first center pole part was 1.0, a flattening treatment was carried out before the soft magnetic metal powder and the resin were mixed. Specifically, isopropyl alcohol (IPA) was added as a solvent to the soft magnetic metal powder to form a slurry, then the soft magnetic metal particles included in the soft magnetic metal powder were pulverized using a bead mill which is a wet pulverizer. After pulverization, IPA was removed by drying using a spray drier. Further, zinc stearate as a lubricant was added to the granules. An added amount of zinc stearate was 0.2 parts by weight or less with respect to 100 parts by weight of the granules. Further, first molding was carried out using a warm molding method. Specifically, first molding was carried out while heating the mold and the granules. Heating was carried out roughly at a heating temperature around the softening point of the resin. Further, first molding was carried out while applying magnetic field in a direction perpendicular to the pressure applying direction.

When the aspect ratio of the center pole part was to be smaller than 5.0, whether or not to carry out a flattening treatment and the condition of the flattening treatment, the molding pressure during core molding, the hardness of the soft magnetic metal powder, the hardness of the resin, and so on were controlled accordingly. As conditions of the flattening treatment, specifically, a pulverization time, a rotational speed of the pulverizer, a concentration of the slurry, a viscosity of the slurry, and so on were controlled accordingly.

When the degree of orientation of the center pole part was to be smaller than 1.0, whether or not to apply the magnetic field, whether or not to apply heat during first molding, the temperature of heating during first molding, whether or not to add the lubricant, the added amount of the lubricant, and so on were controlled accordingly.

### (Base Core)

A production method of the base core was the same as the production method of the center core.

### (Cover Core)

A production method of a pot-shaped cover core was the same as the production method of the center core except that the flattening treatment of the soft magnetic metal powder was not carried out in the production method of the pot-shaped cover core.

### (Insert Member)

The insert member having the coil part 4 shown in FIG. 9 was prepared. A size of the coil part 4 was an inner diameter of 1.5 mm, a height of 1.0 mm, and the material of the coil part 4 was Cu.

### (Integrating Center Core, Base Core, Cover Core, and Insert Member)

First, the base core was inserted in the mold. Next, as shown in FIG. 8, the insert member and the center core were arranged at the predetermined position on the base core. The arrangement direction of the center core at this point is shown in Table 1. When the pressure applied direction of the center core and the winding axis direction of the coil were perpendicular to each other, then it was indicated “perpendicular”; and when the pressure applied direction of the center core and the winding axis direction of the coil were parallel to each other, then it was indicated “parallel”.

Further, as shown in FIG. 8, the pot-shaped cover core was arranged at the predetermined position.

Next, molding was carried out using thermocompression bonding. Specifically, the base core, the center core, the insert member, and the cover core which were placed in the mold were heated at 80° C., and after the resin was softened, pressure was applied. The pressure applying direction was along the winding axis direction. The coil and each core were thermocompressed due to the applied pressure, and these were integrated. The molding pressure during the thermocompression bonding are shown in Table 3.

The inductor 2, which was taken out from the mold after molding using thermocompression bonding, was heated to cure the resin. The heating temperature was within a range of 150° C. to 200° C., and the heating time was within a range of 1 hour to 3 hours.

The inductor shown in FIG. 6 was obtained by going through the above-mentioned steps. The dimension of the inductor was 3 mm×3 mm×2 mm, in which a height was 2 mm.

Sample No. 201, which is a comparative example shown in Table 3, did not use the center core and the below described core material was used instead. Other than this, Sample No. 201 was carried out under the same conditions as Sample Nos. 202 to 204.

### (Core Material)

As the core material, the resin and the soft magnetic metal powder including soft magnetic metal particles were prepared. The material of the soft magnetic metal particles was Fe—Si alloy (Fe 95.5 wt %, Si 4.5 wt %), and hardness of the soft magnetic metal particles was 300 HV. An average particle size of the soft magnetic metal powder was 25 μm. An epoxy resin was used as the resin.

Next, insulation coating layers were formed on the surfaces of the soft magnetic metal particles. Specifically, a SiO₂ layer was formed as the insulation coating layer using a sol-gel method. A thickness of the insulation coating layer was about 40 nm or so.

Next, the soft magnetic metal powder and the resin were mixed, and granules were obtained. Specifically, after the resin was added to and stirred with the soft magnetic metal powder, it was dried at 40° C. for 10 hours. An amount ratio of the resin was as shown in Table 1. The type of the resin was an epoxy resin. After the resin was added to and stirred with the soft magnetic metal powder, it was passed through a mesh to remove coarse granules. Specifically, it was passed through a mesh of 100 μm. The granules obtained at the end had an average particle size of 60 μm or so.

For the obtained inductor, an aspect ratio of the soft magnetic metal particles included in the center pole part, an average degree of orientation Φ1 of the soft magnetic metal particles included in the center pole part, and an average degree of orientation Φ3 of the soft magnetic metal particles included in the exterior part were measured.

Specifically, first, the inductor of each sample was cut along the part which corresponded to a line VI-VI of FIG. 6. The obtained cross section was cut along the part corresponding to a line A′-A′ and the part corresponding to a line B′-B′ of FIG. 7. The cross section along the line A′-A′ was observed using a generally used image analysis device, and a cross section image along the line A′-A′ was obtained. Further, the cross section along the line B′-B′ was observed, and the cross-section image along the line B′-B′ was obtained.

For each cross-section image, an average aspect ratio of the soft magnetic metal particles included in the center pole part was measured. Among the obtained average aspect ratios from each cross-section image, the larger aspect ratio was defined as the average aspect ratio of the soft magnetic metal particles included in the center pole part. Further, using the cross-section image having the larger aspect ratio, Φ1 and Φ3 were measured. Each of these were as shown in Table 3. In each Example, the average degree of orientation Φ1 of the soft magnetic metal particles included in the center pole part was higher than the average degree of orientation Φ3 of the soft magnetic metals included in the exterior part.

Regarding the obtained inductor, inductance L was measured. For measuring inductance, an RF impedance material analyzer (4491A made by Agilent) was used under the conditions of a measuring frequency of 1 MHz and a measuring voltage of 500 mV. Results are shown in Table 3. When inductance was 0.95 μH or larger, it was considered good.

Regarding the obtained inductor, an ESD test (Electrostatic Discharge test) which is in accordance with JEITA ED-4701/302A by HBM (Human Body Model) was carried out. Testing voltage was ±2 kV. Table 3 shows whether the sample passed ESD test.

Regarding the obtained inductor, an impulse breakdown voltage test (impulse BDV test) was carried out. The impulse BDV test was carried out using an impulse winding tester (19301A made by Chroma) under impulse winding test breakdown voltage mode (IWT BDV MODE). Specifically, AC pulse signal with a predetermined maximum amplitude was input to the sample (inductor) to measure a standard pulse wave. Next, an evaluation pulse signal was input, and a pulse wave detected in response to the evaluation pulse signal was obtained. The pulse signal was obtained by gradually increasing the measuring voltage. When an area of the pulse wave was smaller than 2.0% of an area of a standard pulse wave, the measuring voltage at this point was defined as a breakdown voltage. That is, when the area of the obtained pulse wave was smaller than 2.0% of the area of a standard pulse wave, it was determined that short circuit had occurred between the conductors of the coil part. The measuring voltage was within a range of 50 V to 350 V (a measuring voltage step: 1%), and a number of pulse application was 1. In Table 3, when breakdown did not occur at the measuring voltage of 350 V, that is, when the breakdown voltage was larger than 350 V, it was indicated “pass”; and when breakdown occurred at the measuring voltage of 350 V or lower, that is, when the breakdown voltage was 350 V or lower, then it was indicated “short”.

TABLE 3

| | | | | | | | Resin | | | | |
|---|---|---|---|---|---|---|---|---|---|---|---|
| | | | | Aspect | | | amount | | | | |
| | | | | ratio | Φ 1 of | | of pot- | Pressure | | | Impulse test |
| | Example/ | | Center core | of first | first | Φ 3 of | shaped | of heat | | ESD test | Breakdown |
| Sample | Comparative | Shape of | direction | center | center | exterior | core | compression | L | HBM ± | voltage > |
| No. | example | center core | arranged | part | part | part | [wt %] | [MPa] | [μH] | 2 kV | 350 V |
| 201 | Comparative | NONE | [symbol] | 1.1 | [symbol] | 0.0 | 2.4 | 300 | [symbol] | Pass | Pass |
| | example | | | | | | | | | | |
| 202 | Example | Square | Perpendicular | 1.1 | 0.1 | 0.0 | 2.4 | 300 | 0.96 | Pass | Pass |
| | | prism shape | | | | | | | | | |
| 203 | Example | Square | Perpendicular | 1.1 | 0.5 | 0.0 | 2.4 | 300 | 0.97 | Pass | Pass |
| | | prism shape | | | | | | | | | |
| 204 | Example | Square | Perpendicular | 1.1 | 1.0 | 0.0 | 2.4 | 300 | 0.98 | Pass | Pass |
| | | prism shape | | | | | | | | | |
| 205 | Comparative | Square | [symbol] | 1.5 | [symbol] | 0.0 | 2.4 | 300 | [symbol] | Pass | Pass |
| | example | prism shape | | | | | | | | | |
| 206 | Example | Square | Perpendicular | 1.5 | 0.1 | 0.0 | 2.4 | 300 | 0.98 | Pass | Pass |
| | | prism shape | | | | | | | | | |
| 207 | Example | Square | Perpendicular | 1.5 | 0.5 | 0.0 | 2.4 | 300 | 1.00 | Pass | Pass |
| | | prism shape | | | | | | | | | |
| 208 | Example | Square | Perpendicular | 1.5 | 1.0 | 0.0 | 2.4 | 300 | 1.04 | Pass | Pass |
| | | prism shape | | | | | | | | | |
| 209 | Comparative | Square | [symbol] | 3.0 | [symbol] | 0.0 | 2.4 | 300 | [symbol] | Pass | Pass |
| | example | prism shape | | | | | | | | | |
| 210 | Example | Square | Perpendicular | 3.0 | 0.1 | 0.0 | 2.4 | 300 | 0.99 | Pass | Pass |
| | | prism shape | | | | | | | | | |
| 211 | Example | Square | Perpendicular | 3.0 | 0.5 | 0.0 | 2.4 | 300 | 1.06 | Pass | Pass |
| | | prism shape | | | | | | | | | |
| 212 | Example | Square | Perpendicular | 3.0 | 1.0 | 0.0 | 2.4 | 300 | 1.15 | Pass | Pass |
| | | prism shape | | | | | | | | | |
| 213 | Comparative | Square | [symbol] | 5.0 | [symbol] | 0.0 | 2.4 | 300 | [symbol] | Pass | Pass |
| | example | prism shape | | | | | | | | | |
| 214 | Example | Square | Perpendicular | 5.0 | 0.1 | 0.0 | 2.4 | 300 | 1.00 | Pass | Pass |
| | | prism shape | | | | | | | | | |
| 215 | Example | Squa re | Perpendicular | 5.0 | 0.5 | 0.0 | 2.4 | 300 | 1.10 | Pass | Pass |
| | | prism shape | | | | | | | | | |
| 216 | Example | Square | Perpendicular | 5.0 | 1.0 | 0.0 | 2.4 | 300 | 1.24 | Pass | Pass |
| | | prism shape | | | | | | | | | |

Each example having the center pole part with Φ1 of 0.1 or larger had a higher inductance L compared to each comparative example having Φ1 of 0.0 or smaller.

### Experiment Example 4

In Experiment example 4, the resin amount of the cover core and the molding pressure were adjusted so that inductance L was 1.00 μH. Other than this point, Experiment example 4 was carried out under the same conditions as Experiment example 3. Results are shown in Table 4.

TABLE 4

| | | | | | | | Resin | | | | |
|---|---|---|---|---|---|---|---|---|---|---|---|
| | | | | Aspect | | | amount | | | | |
| | | | | ratio | Φ 1 of | | of pot- | Pressure | | | Impulse test |
| | Example/ | | Center core | of first | first | Φ 3 of | shaped | of heat | | ESD test | Breakdown |
| Sample | Comparative | Shape of | arranged | center | center | exterior | core | compression | L | HBM ± | voltage > |
| No. | example | center core | direction | part | part | part | [wt %] | [MPa] | [μH] | 2 kV | 350 V |
| 301 | Comparative | NONE | [symbol] | 1.1 | [symbol] | 0.0 | 1.8 | 390 | 1.00 | [symbol] | [symbol] |
| | example | | | | | | | | | | |
| 302 | Example | Square | Perpendicular | 1.1 | 0.1 | 0.0 | 2.4 | 320 | 1.00 | Pass | Pass |
| | | prism shape | | | | | | | | | |
| 303 | Example | Square | Perpendicular | 1.1 | 0.5 | 0.0 | 2.4 | 320 | 1.00 | Pass | Pass |
| | | prism shape | | | | | | | | | |
| 304 | Example | Square | Perpendicular | 1.1 | 1.0 | 0.0 | 2.4 | 310 | 1.00 | Pass | Pass |
| | | prism shape | | | | | | | | | |
| 305 | Comparative | Square | [symbol] | 1.5 | [symbol] | 0.0 | 2.1 | 340 | 1.00 | [symbol] | Pass |
| | example | prism shape | | | | | | | | | |
| 306 | Example | Square | Perpendicular | 1.5 | 0.1 | 0.0 | 2.4 | 310 | 1.00 | Pass | Pass |
| | | prism shape | | | | | | | | | |
| 307 | Example | Square | Perpendicular | 1.5 | 0.5 | 0.0 | 2.4 | 300 | 1.00 | Pass | Pass |
| | | prism shape | | | | | | | | | |
| 308 | Example | Square | Perpendicular | 1.5 | 1.0 | 0.0 | 2.4 | 280 | 1.00 | Pass | Pass |
| | | prism shape | | | | | | | | | |
| 309 | Comparative | Square | [symbol] | 3.0 | [symbol] | 0.0 | 2.1 | 380 | 1.00 | [symbol] | [symbol] |
| | example | prism shape | | | | | | | | | |
| 310 | Example | Square | Perpendicular | 3.0 | 0.1 | 0.0 | 2.4 | 300 | 1.00 | Pass | Pass |
| | | prism shape | | | | | | | | | |
| 311 | Example | Square | Perpendicular | 3.0 | 0.5 | 0.0 | 2.7 | 260 | 1.00 | Pass | Pass |
| | | prism shape | | | | | | | | | |
| 312 | Example | Square | Perpendicular | 3.0 | 1.0 | 0.0 | 3.0 | 210 | 1.00 | Pass | Pass |
| | | prism shape | | | | | | | | | |
| 313 | Comparative | Square | [symbol] | 5.0 | [symbol] | 0.0 | 1.8 | 400 | 1.00 | [symbol] | [symbol] |
| | example | prism shape | | | | | | | | | |
| 314 | Example | Square | Perpendicular | 5.0 | 0.1 | 0.0 | 2.4 | 300 | 1.00 | Pass | Pass |
| | | prism shape | | | | | | | | | |
| 315 | Example | Square | Perpendicular | 5.0 | 0.5 | 0.0 | 2.7 | 240 | 1.00 | Pass | Pass |
| | | prism shape | | | | | | | | | |
| 316 | Example | Square | Perpendicular | 5.0 | 1.0 | 0.0 | 3.0 | 160 | 1.00 | Pass | Pass |
| | | prism shape | | | | | | | | | |

When the production conditions were controlled so that each example having Φ1 of 0.1 or larger and each comparative example having Φ1 of 0.0 or smaller had the same inductance L, each comparative example exhibited deteriorated results of breakdown voltage test and/or inductance test. It is thought because the resin amount was too small and the molding pressure during thermocompression bonding was too high.

Each example having the center core with Φ1 of 0.1 or larger was able to maintain a high inductance L even when the resin amount was increased in the cover core, that is, in the exterior part, or even when the molding pressure during thermocompression bonding was decreased or increased. That is, load to the coil during the production of the coil was reduced while maintaining a high inductance.

### REFERENCE SIGNS LIST

2 . . . Inductor
4 . . . Coil part
5 . . . Conductor
5a,5b . . . Lead wire part
6a . . . Center pole part
6aa . . . First center pole part
6ab . . . Second center pole part
6c,6d . . . Exterior part
6a1 . . . Center core
6c1 . . . Base core
6d1 . . . Cover core

What is claimed is:

1. A coil component comprising a core part and a coil part formed by winding a conductor in a coil form, wherein
the coil part is inside of the core part;
the core part comprises a center pole part positioned in an area surrounded by an inner diameter of the coil part;
the center pole part comprises a first center pole part including first soft magnetic metal particles, and a second center pole part including second soft magnetic metal particles and being arranged around the first center pole part;
the first center pole part comprises at least two opposing faces opposing each other;
the two opposing faces are parallel to a winding axis direction; and
an average deflection angle of the first soft magnetic metal particles against the winding axis direction of the coil part and an average deflection angle of the second soft magnetic metal particles against the winding axis direction of the coil part are different.

2. The coil component according to claim 1, wherein a shape of the first center pole part is a quadrangular prism shape.

3. The coil component according to claim 1, wherein
an average value of cos 2θα is larger than an average value of cos 2θβ, in which θα represents deflection angles of the first soft magnetic metal particles against the winding axis direction of the coil part and θβ represents deflection angles of the second soft magnetic metal particles against the winding axis direction of the coil part.

4. The coil component according to claim 1, wherein
an average value of cos 2θα is larger than an average value of cos 2θγ, in which θα represents deflection angles of the first soft magnetic metal particles against the winding axis direction of the coil part and θγrepresents deflection angles of third soft magnetic metal particles included in an area outside of the coil part against the winding axis direction of the coil part.

5. The coil component according to claim 1, wherein
an average value of cos 2θα is 0.1 or larger, in which θα represents deflection angles of the first soft magnetic metal particles against the winding axis direction of the coil part.

6. The coil component according to claim 1, wherein an average aspect ratio of the first soft magnetic metal particles included in the first center pole part is 1.1 or larger and 5.0 or smaller.

7. A coil component comprising a core part and a coil part formed by winding a conductor in a coil form, wherein
the coil part is inside of the core part;
the core part comprises a center pole part positioned in an area surrounded by an inner diameter of the coil part;
the center pole part comprises a first center pole part including first soft magnetic metal particles, and a second center pole part including second soft magnetic metal particles and being arranged around the first center pole part;
the first center pole part comprises at least two opposing faces opposing each other; and
the two opposing faces are parallel to a winding axis direction.

8. A coil component comprising a core part including soft magnetic metal particles, and a coil part formed by winding a conductor in a coil form, wherein
the coil part is inside of the core part;
the core part comprises a center pole part positioned in an area surrounded by an inner diameter of the coil part;
an average value of cos 2θ of the soft magnetic metal particles included in the center pole part is 0.1 or larger, in which θ represents deflection angles of the soft magnetic metal particles against the winding axis direction of the coil part; and
an average aspect ratio of the soft magnetic metal particles included in the center pole part is 1.1 or larger.

9. The coil component according to claim 8, wherein the average aspect ratio of the soft magnetic metal particles included in the center pole part is 1.1 or larger and 5.0 or smaller.

10. The coil component according to claim 8, wherein the core part comprises a dust core including the soft magnetic metal particles and a resin.

11. A production method of the coil component according to claim 8 comprising the core part including the soft magnetic metal particles and the coil part formed by winding the conductor in a coil form, in which the coil part is inside the core part; wherein
the production method of the coil component comprises
preparing a center core by pressing; and
arranging the center core so that a pressure applied direction of the center core while pressing and a winding axis direction of the coil part are perpendicular to each other.

12. The production method according to claim 11 comprising:
preparing a coil, a base core, and cover core;
arranging the center core, the coil, and the cover core on the base core; and
integrally pressing the base core, the center core, and the cover core.
